(19) United States
(12) Patent Application Publication
(10) Pub. No.: US 2020/0351316 A1
(43) Pub. Date: Nov. 5, 2020

(54) SYSTEMS AND METHODS FOR SHARING MEDIA CONTENT

(71) Applicant: Ford Global Technologies, LLC, Dearborn, MI (US)

(72) Inventors: Yifan CHEN, Ann Arbor, MI (US); Pramita MITRA, West Bloomfield, MI (US); Abhishek SHARMA, Plymouth, MI (US); Qianyi WANG, Allen Park, MI (US)

(21) Appl. No.: 16/764,965

(22) PCT Filed: Nov. 21, 2017
(86) PCT No.: PCT/US2017/062824

§ 371 Date: May 18, 2020

(51) Int. Cl. H04L 29/06; H04L 29/08; H04L 12/58; G06F 16/435; G06F 16/438; G06F 16/2457; G06N 20/00

(52) U.S. Cl. CPC H04L 65/4076; H04L 67/306; H04L 65/60; H04L 67/18; G06N 20/00; G06F 16/435; G06F 16/4387; G06F 16/24578; H04L 51/10

(57) ABSTRACT

An infotainment system includes a transceiver to receive media content from a plurality of sources and communicate with a plurality of user devices and a broadcast device configured to broadcast media content. The infotainment system also includes a controller programmed to query the user devices for at least one media preference factor, and generate a composite public playlist based on an arbitration between different media preference factors received from the user devices.

### TECHNICAL FIELD

The present disclosure relates to management of media content for broadcast to users.

### BACKGROUND

Direct streaming and broadcast of media content is available on a single user and or single playlist basis. Broadcasting media content to a community of recipients may include varying degrees of acceptance between groups of users within the community of recipients. Thus, the user experience of certain users may be less than optimal based on individual dissatisfaction with the selection of media content for broadcast.

### SUMMARY

An infotainment system includes a transceiver to receive media content from a plurality of sources and communicate with a plurality of user devices and a broadcast device configured to broadcast media content. The infotainment system also includes a controller programmed to query the user devices for at least one media preference factor, and generate a composite public playlist based on an arbitration between different media preference factors received from the user devices.

A method of managing media content includes querying a user media preference from each of a plurality of user devices and assigning a composite score to a media type based on a plurality of media preference factors. The method also includes generating a media file playlist based on ranking a composite score associated with each of a plurality of media files. The method further includes broadcasting a sequence of media files according to the media file playlist.

A vehicle includes an infotainment system programmed to communicate with a plurality of user devices, receive media content from a plurality of sources, and broadcast the media content to users in a vicinity. The vehicle also includes a controller programmed to query the plurality of user devices for user media preferences and generate a ranking of candidate media files based on the user media preferences. The controller is also programmed to generate a public media playlist for broadcast to the users in the vicinity based on the ranking. The controller is further programmed to cause the infotainment system to receive media content according to the media playlist.

### BRIEF DESCRIPTION OF THE DRAWINGS

FIG. 1 depicts an illustrative vehicle computing system.

FIG. 2 is a schematic block diagram of an infotainment system.

FIG. 3 is a flowchart of a method of managing media content.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Consumption of media files including music, videos, news broadcasts, and other media types can be a non-trivial aspect of a user's experience in a community situation providing broadcast media. When a collection of multiple users is within a common vicinity of a media broadcast device, each of the users may have a different impression of the media being broadcast. For example, in the case of a shuttle vehicle carrying several passenger users, broadcasting ill-received music cause a decrease in shuttle ride ratings from the passenger users. Similarly, a social public gathering such a as party may rely on a single media broadcast device for providing media content to all attendees. Based on a range of media preferences, attendee users may have different impressions of the broadcast media.

Certain programs may allow users within a common vicinity to choose their own media files to play through a central infotainment system. Returning to the example of a vehicle shuttle, the vehicle may include an infotainment system having speakers to broadcast music media content during their trips to enhance trip satisfaction. A unique challenge is presented by the presence of multiple users, each having a unique set of musical preferences. More specifically, in certain public places users who are strangers to each other convene in the same vicinity. Being unknown to each other, the users may have a wide array of media consumption tastes.

According to other aspects, the duration of time each user is in the vicinity may also vary, which may affect the duration of available media consumption for each individual user. Returning to the example of a passenger shuttle vehicle carrying a plurality of users, the duration each user is present in the vicinity of the vehicle may be limited to a corresponding passenger ride duration. Comparatively, the duration of a guest's time at a party may generally be longer relative to a passenger ride duration of a trip in a shuttle vehicle for an individual rider. The reduced duration in the vicinity of the infotainment system may cause difficulty in providing a positive media consumption experience within a shorter timeframe.

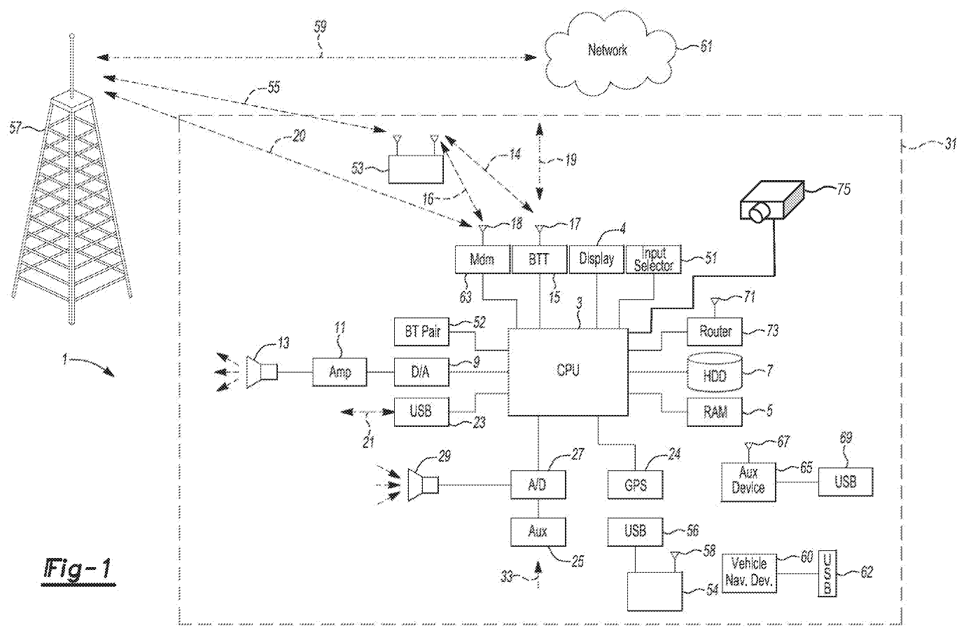

Referring to FIG. 1, an example block topology is depicted for a vehicle-based computing system (VCS) 1 for a vehicle 31. The VCS 1 may be configured to cooperate with a visual front-end interface such as user display 4 located in the vehicle. A user may also be able to interact with the interface, for example, using a touch-sensitive screen. In another illustrative example, the interaction occurs through, button presses, audible speech and speech synthesis.

In the illustrative example of FIG. 1, a central processing unit (CPU) 3 controls at least some portion of the operation of the VCS 1. Provided within the vehicle, the CPU 3 allows onboard processing of commands and routines. Further, the processor is connected to both non-persistent 5 and persistent storage 7. In the example of FIG. 1, the non-persistent storage is random access memory (RAM) and the persistent storage is a hard disk drive (HDD) or flash memory.

The CPU 3 also operates with a number of different inputs allowing the user to interface with the processor. In this example, a microphone 29, an auxiliary input 25 (for input 33), a USB input 23, a global positioning system (GPS) input 24 and a BLUETOOTH input 15 are all provided. An input selector 51 is also provided, to allow a user to swap between various inputs. Input to both the microphone 29 and the auxiliary input 25 is converted from analog to digital (A/D) by an A/D converter 27 before being passed to the CPU 3. Although not shown, numerous of the vehicle components and auxiliary components in communication with the VCS 1 may use a vehicle network (such as, but not limited to, a CAN bus) to pass data to and from the VCS 1 (or other associated components thereof).

Outputs of the VCS 1 can include any of a number of different broadcast devices configured to broadcast media content, including, but not limited to, visual output via the user display 4 and audible output via a speaker 13 or stereo system output. The speaker 13 may also be connected to an amplifier 11 and receives an output signal from the CPU 3 through a digital-to-analog (D/A) converter 9. Wireless signals can also be output to a remote BLUETOOTH device such as first user mobile device 54 along the bi-directional data streams shown at 19. Signals may further be output via a USB connection to a device such as vehicle navigation device 60 along the bi-directional data streams shown at 21.

In one illustrative example, the VCS 1 uses a BLUETOOTH module 15 to communicate via a wireless transceiver 17 with a second user mobile device 53 (e.g., cell phone, smart phone, personal device assistant (PDA), or any other device having wireless remote network connectivity). The second user mobile device 53 may in turn be used to communicate 59 with a network 61 outside the vehicle 31 through, for example, communication 55 with a cellular tower 57. In some examples, cellular tower 57 may be a WiFi access point.

Exemplary communication between the any of the plurality of user devices and the wireless transceiver 17 is represented by signal 14. Pairing the second user mobile device 53 and the BLUETOOTH module 15 can be instructed through a button 52 or similar input. Accordingly, the CPU 3 may provide instructions that when executed, cause the onboard BLUETOOTH module 15 to be paired with a BLUETOOTH transceiver in a within any number of user mobile devices.

Data may be communicated between CPU 3 and network 61 utilizing, for example, a data-plan, data over voice, or dual tone multi frequency (DTMF) tones associated with second user mobile device 53. Alternatively, it may be desirable to include an onboard modem 63 having antenna 18 to communicate 16 data between CPU 3 and network 61 over the voice band. The second user mobile device 53 can also be used to communicate 59 with a network 61 outside the vehicle 31 through, for example, communication 55 with a cellular tower 57. In some examples, the modem 63 may establish communication 20 with the tower 57 for communicating with network 61. As a non-limiting example, modem 63 may be a USB cellular modem and communication 20 may be cellular communication.

In some examples, the CPU 3 is provided with an operating system including an application programming interface (API) to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols.

IEEE 802 local area network (LAN) protocols include WiFi and have considerable cross functionality with IEEE 802 PAN. Both are suitable for wireless communication within a vehicle. Another communication means that can be used in this realm is free-space optical communication (such as IrDA) and non-standardized consumer infrared (IR) protocols.

In further examples, any of the plurality of user mobile devices includes a modem for voice band or broadband data communication. In the data-over-voice example, frequency division multiplexing may be implemented such that a user can talk over the mobile device while data is being transferred. At other times, when the user is not using the device, the data transfer can utilize a greater portion of the bandwidth (300 Hz to 3.4 kHz in one example). While frequency division multiplexing may be common for analog cellular communication, other data transfer forms hybrids of with Code Domian Multiple Access (CDMA), Time Domain Multiple Access (TDMA), Space-Domian Multiple Access (SDMA) may also be used for digital cellular communication. These forms of communication may be classified as 3G standards, but it should be appreciated that still further forms of communications such as IMT-Advanced (4G) may be used and provided greater data transfer rates. In still further examples, the any of the user mobile devices may be a wireless local area network (LAN) device capable of communication over, for example (and without limitation), an 802.11g network (i.e., WiFi) or a WiMax network.

In some examples, incoming data can be passed through the any of the user mobile devices via a cellular data plan, through the onboard BLUETOOTH transceiver and onto the CPU 3. In the case of certain temporary data, for example, the data can be stored on the HDD or other storage media 7 until such time as the data is no longer needed.

Further, the CPU 3 can be in communication with a variety of other auxiliary devices 65. These devices can be connected through a wireless connection 67 and/or wired connection 69. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In some examples, the CPU 3 is in communication with a video source 75 such as a digital video camera. The video source 75 may be integrated as part of a vehicle and generate image data depicting interior portions and/or exterior portions of the vehicle 31. More specifically images depicting the vicinity of the vehicle may include data indicative of the presence or behaviors of users consuming media content broadcast by the infotainment system.

In addition to having exemplary processes executed by a vehicle computing system located in a vehicle, the exemplary processes may also be executed by a computing system in communication with the vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain examples particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the VCS 1 provided with the vehicle itself is capable of performing the exemplary processes.

Examples according to the present disclosure provide an artificial intelligence (AI) enabled approach to enable an adaptive media content sharing for a group of users within a vicinity of the infotainment system, such as riders in a shuttle. This present disclosure also provides algorithms to create smart media content sharing with dynamic selections from a plurality of different media sources (AM/FM/Sirius/Internet Radio/Connected mobile device) and incorporate real-time user feedback.

One advantage over existing solutions such as streaming internet radio is that previous configurations may provide only single-user and/or single-source media playback solutions. In contrast, examples according to the present disclosure provide media content sharing solutions to simultaneous multiple users while incorporating different, multiple sources. Examples provided by the present disclosure are also capable of accounting for multi-modal, real-time feedback from nearby users (text, audio conversation, video, etc.) and in response adjusting the playlist in real-time.

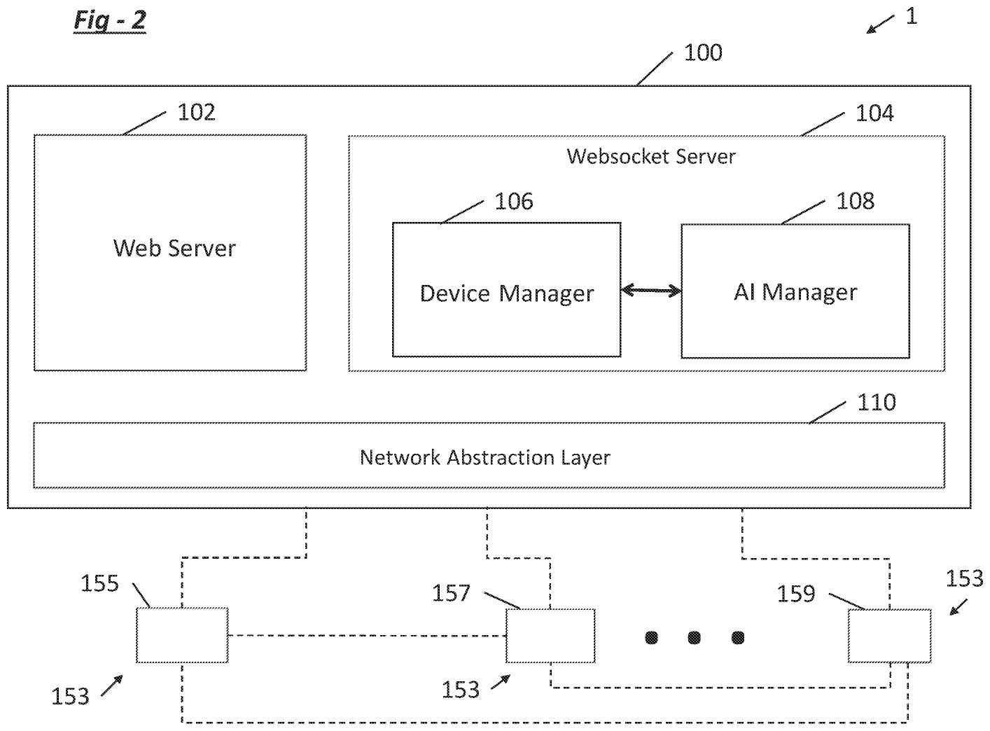

Referring to FIG. 2, the VCS 1 is represented by a block diagram depicting components of an infotainment operating system 100. Components of the infotainment operating system 100 store one or more algorithms to manage the playback of media content. According to some examples, media content management features merge media content from a plurality of sources (e.g., AM/FM/Sirius XM channels, streaming from Internet Radio, podcasts, videos, news feeds, etc.) The infotainment operating system 100 includes an architecture that is based on a client-server model. The client side of the architecture may include applications stored at a one of more user mobile devices 153. Each of the clients and the server is connected to the cloud individually. Media content management features may be hosted and rendered within another native multifunction mobile device application. For example, media content management features may be included as part of a vehicle shuttle application programmed to facilitate mobile application users to coordinate shuttle rides. In another example, media content management features may be provided as part of a jukebox mobile application used to broadcast media content while different users come into, and out of the vicinity of a static infotainment system.

The server side of the infotainment operating system 100 includes two primary components. Both of a web server component 102 and a websocket server component 104 may each be included with algorithms stored on the infotainment system 100.

The web server component 102 is responsible for hosting and serving the jukebox control user interface resources to the clients.

The websocket server component 104 provides full-duplex persistent connection between the client user devices 153 and media management modules of the SYNC system. A device manager module 106 stored within the websocket server component 104 is programmed to handle interactions across any number of user mobile devices 153 (e.g., first user mobile device 155, second user mobile device 157, up through nth user mobile device 159). The device manager module 106 may also be programmed to resolve simultaneous access requests from multiple client devices 153 (e.g., two or more riders requesting to change the FM radio station) and synchronous updating of the user interface on multiple clients.

The device manager module 106 is also configured to handle decisions how to serialize access to media content management portions of the infotainment system 100 when more than one user devices 153 requests access. Access can be serialized either based on request submission time (e.g., user 1 submits request before user 2), or based on user priority levels that may be allow the device manager module to override request submission time (e.g., user 2 has paid for jukebox access service having upgraded permissions).

The device manager module 106 may be further configured to enable client-to-client communications between any of the plurality of user devices 153. For instance, users can send chat messages amongst themselves using the mobile device app to discuss particular media files and/or the playlist. Client-to-client communications may be broadcasting based in nature, such that when the device manager module 106 receives the chat messages from any particular client, it programmed to broadcast the message to all of the user devices 153 in the vicinity. In this way the communication format may be analogous to a group chat room.

The websocket server component 104 also includes an AI manager module 108 programmed to be responsible for playlist creation using individualized data profiles associated with each of the plurality of user mobile devices 153, as described in more detail below. The AI manager module 108 may use multiple input channels to monitor the connected users and understand their responses to the media content being broadcast. Also described in more detail below, the multiple input channels may include any combination of textual messages, oral discussion (user audio feedback), and facial expression or other visual indicators (user video feedback). The AI manager module 108 may also use advanced AI algorithms including Natural Language Understanding (NLU) engine (for example, related to messages and speech) and computer vision techniques (for example, facial recognition algorithms) to process and analyze data from these multiple input channels, and derive actionable insights.

The infotainment system may be further configured to monitor user responses via textual inputs. For example, the AI manager module 108 is programmed to monitor messages transmitted between the plurality of user devices, and analyze the messages to develop context regarding a group discussion about a particular genre, artist, or song. In response to approval indicators detected within the messages the AI manager module 108 is further programmed to adjust a user preference score and/or playlist sequence as discussed in more detail below.

The infotainment system may be further configured to monitor user responses via audio inputs. For example, the AI manager module 108 compares the music with the audio signals provided from a local audio input device such as a microphone embedded on a shuttle vehicle or a user mobile device microphone. The AI manager module 108 in turn analyzes the audio input to filter and separate user feedback comments (e.g., “I love this new song from Eminem,” or “Katy Perry is performing at Ford Field next week”) from the music itself. Comments indicating an attribute such as particular media content source, song, artist, genre or the like may be used to determine user approval of the detected attribute. More specifically, the AI manager module 108 is programmed to detect audible approval indicators associated with a particular media content attribute. In response to approval indicators detected within the verbal feedback of users within the vicinity of the infotainment system, the AI manager module 108 is further programmed to adjust a user preference score and/or playlist sequence as discussed in more detail below.

The infotainment system may be further configured to monitor user responses via video inputs. For example, the AI manager module 108 monitors and analyzes video data to detect user emotional response from the infotainment system video feeds in real-time. Visual indicators of user approval may be detected while a particular media content is being broadcast. For example, detected visual indicators, including for example, bobbing, dancing, smiling may be considered positive user feedback indicators. Conversely the AI manager module 108 may store algorithms to recognize negative user feedback indicators, for example such as frowning. Each of the positive and negative user visible feedback indicators may be used to adjust a user preference score and/or playlist sequence as discussed in more detail below.

Upon understanding user feedback response, the AI manger can identify other relevant media content from the various sources and update the playlist. According to some examples, the audio inputs, video inputs, and textual inputs may each be used to conduct arbitration through various weighting and scoring techniques to make decisions about upcoming media content to best appease the greatest number of users in the vicinity of the infotainment system. In a specific example, such scoring and weighting is used to rank media files in the media playlist and develop and evolve a group playlist suitable to the larger group of users. In this way the infotainment system is configured to merge media content from various hybrid sources based on a collective media content preference of number of users. The media content preference can be determined by at least one of an environmental factor, a user demographic, and a user media consumption pattern.

Environmental factors considered in generating a media content preference may include any combination of user route duration, user route destination, textual user feedback, audible user feedback, visible user feedback, traffic conditions, weather, time of day, passenger route duration overlap with other passengers, as well as other environmental attributes.

The media consumption pattern may include attributes such as historical likes and dislikes, playback frequency and/or timing of certain media content, media content survey responses, or other attributes indicative of a particular user's media consumption.

The user demographic may include information associated with a user profile such as age, gender, ethnicity, geographic residence or origin, social media account information, or other information concerning the identity or personality of a particular user. Algorithms stored at the infotainment system may select upcoming media content based on the intersection of various user profiles. For example, the infotainment system may detect a number of users who frequently consume newsfeeds. So long as no passenger has provided negative feedback concerning news feeds, a news feed may be scored highly and thus selected as part of the upcoming media content playlist. The media content preferences are reassessed on an ongoing or periodic basis to update the playlist of upcoming media content as nearby users come into and depart from the vicinity of the infotainment system.

According to some examples, a personalized user profile is created when the media content management application is downloaded. User accounts store a personalized music profile for each. In some cases, users may be requested to take a survey questionnaire in order to rate media content sources, genres, artists, songs, or other media attributes upfront. Such questions and responses pertaining to user general perception of various media content categories can go into weighting factors when determining a playlist and user propensity to enjoy candidate media sources to be selected for the playlist.

Similarly, the initial user personalized user profile includes demographic information as discussed above. Also, historical media consumption indicators may be stored along with the personalized user profile, including for example, a user's rating of music in the past trips using the shuttle app. A user's personalized media profile is continuously updated based on the usage behavior of these apps. The infotainment system may be programmed to mine all available data associated with a user to search for indicators of media preferences. In some examples, personalized media profile includes a user's favorite genres and top 20 songs within each of those genres.

A user's age may be compared to the age of the particular media content file or genre, and the comparison generates a value to influence the user demographic component of the media preference factor associated with the media content file. The adjustment of the demographic component in turn affects the likelihood that the media content file will be selected for broadcast.

Similarly a user's ethnicity may be used to influence the user demographic component of the media preference factor associated with a media content file. People of different ethnicities often associate with certain patterns of media content choices. The designation of a user's ethnicity as part of the user profile may provide the basis for adjustment of the user demographic component of the media preference factor.

A user's gender of a user may further be used to influence the user demographic component of the media preference factor associated with a media content file. The designation of a user's gender may be included as a response to a question presented upon account setup.

Geographic location of a user's designated home may also influence media content choices. For example users may be more inclined to have a positive impression of local artists, or other artists which are popular in a home region. The designation of a user's home location may be added to a user profile via a response to a question presented upon account setup, and may be used to influence the user demographic component of the media preference factor associated with a media content file.

Geographic location may also be used to may be used to influence the environmental factor component of the media preference factor associated with a media content file. More specifically, the infotainment system may be programmed to communicate with a GPS module to obtain a real-time location. The present location of the vehicle relative to a final user route destination, and other factors such as traffic conditions, may feed into a calculation of the remaining trip duration of a passenger.

A user's social media profile may provide further indications of a user's media consumption preferences and thus serve as a factor to predict certain patterns of media content choices. A user may be requested to allow access to one or social media profiles upon account setup. The infotainment system may thus draw information from social media accounts such as Facebook, Twitter, Snapchat, etc. User postings which include information indicative of a user perception of an artist, song, or genres may be used as a weighting factor to influence a user reference score pertaining to candidate media content to be added to future media playlists. The infotainment system may be programmed to analyze user social media postings similar to text messages to determine the presence of user feedback indicators.

Further upon user account setup, a user may be requested to grant access to a media player of choice. In this way a user's selection of favorites within another mobile app may be imported and used as a factor into weighting of selection of candidate media sources for future playlists. Patterns associated with selection of favorites, historical plays of media content extracted from a media player app may help influence the user media consumption pattern component of the media preference factor. The media preferences account profile may further draw information from music streaming apps such as Pandora, Spotify, Apple Music, Google Play, etc. regarding media consumption patterns.

The current weather conditions may also be used to influence selection of media content for playlist generation. Information from a weather service provider may be used by a controller of the infotainment system to weight candidate media content files for determination of whether or not to incorporate certain files into a media playlist. Media content that makes reference to weather aspects may receive an increased environmental factor component of the media preference factor when that particular weather aspect is present in the current weather conditions.

A shuttle vehicle including an infotainment system according to the present disclosure may receive a list of riders with reservations for an upcoming stop. The infotainment system may query the upcoming riders' personalized media profiles from a central server and calculate an intersection of media preferences of the upcoming riders, as well as currently-onboard riders who would travel beyond the upcoming stop. In this way the infotainment system can best arbitrate the different preferences of multiple users to generate a best-fit composite public playlist to suit all user preferences.

Once one or more matching genres are found, media files from those genres are added to a playlist as upcoming media content. In at least one example, the media files are music files, and selected at least in part based on musical preferences. In other examples, the media content includes video content such as music videos, new feeds, podcasts, informational videos, documentaries, movies, TV shows or other video content. With reference to music files, the selection of the actual songs from one or more identified genres can also depend on the song duration in light of the trip duration of each of the riders whose personalized music profiles are being considered for playlist creation.

According to some examples, a cost function for media content genre selection is operates to minimizes the overall unhappiness of all riders during any point of time during their trip duration. More specifically, a score of candidate song F, equals a sum of a score function of genre plus a cost function of time, plus a function of a given song's rating. equation (1) below is an example scoring function.

F=w₁×score_{genre}+w₂×scoreₜᵢₘₑ+w₃×score_{rating} (1)

In equation (1) above, F is a score of a candidate media file, score_{genre} is a score applied to the relevant genre of the candidate file, scoreₜᵢₘₑ is a score applied to the candidate file based on the file duration relative to the remaining duration of a user's trip, and score_{rating} is a score applied to the candidate media file based on a user rating of the particular song. Each of w₁, w₂, and w₃ are weighting functions that take into account user response, environmental factors, and media type as arguments. Thus the score F may be dynamically shifted based on the situation. For example, if a group of users has a particularly short overlapping passenger ride duration, w₂ may be increased to heighten the sensitivity of the duration of candidate media files. It should be appreciated that while an example score function is provided above, it is a non-limiting example and numerous other inputs may be used to develop a comprehensive weighting score for use in selecting from candidate media files for a media playlist.

With continued reference to equation (1) above, one example calculation of score_{genre} is provided in equation (2) below.

$$s c o r {e}_{genre} = {\sum }_{k = 1}^{n} \frac{{N}_{k}}{rank} \qquad ( 2 )$$

In equation (2) above, rank represents there are k people evaluate the song in the same rank. Nₖ represents number of people in rank group k. According to one specific example, in a case where one person ranks the media type as 1, three people rank the media type as 2, and two people rank the media type as 3, the rank_{genre}=1/1+3/2+2/3=13/6

With further reference to equation (1) above, one example calculation of scoreₜᵢₘₑ is provided by equation (3) below.

$$s c o r {e}_{time} = \frac{median ( trip left time )}{song period} \qquad ( 3 )$$

In equation (3) above, median(trip left time) represents the median remaining trip duration for the passengers present at the expected time of broadcast of the candidate media file. For example, the next media file in the playlist may be scored based on present passengers, and a media file intended for broadcast in the future may consider the duration of remaining ride of upcoming passengers onboard at the time of broadcast. song period represents the play duration of the candidate media file. Generally, if a majority of user passengers will arrive the destination in a shorter duration, a shorter period media file would be assigned a higher score relative to a longer period media file. The trip left time for each passenger user may be calculated based on real-time traffic instead of static speed limit, so that if the trip time between certain stops is longer than usual because of a traffic jam, the playlist is adjusted for a longer duration (broadcast of more media files or longer duration media files become feasible via higher scores).

Considering a specific example shuttle vehicle having an infotainment system according to the present disclosure, there may be a total of three riders onboard at the time of broadcast of a media file (e.g., two new riders coming onboard having upcoming shuttle reservations, and 1 existing rider continuing at the time of broadcast). A first rider rider₁'s destination may include a remaining travel duration of about 15 minutes to arrive, a second rider rider₂'s destination may include a remaining travel duration of about 30 minutes to arrive, and a third rider rider₃'s destination may include a remaining travel duration of about 45 minutes to arrive. In this example case, median(trip left time) equals thirty minutes. Thus a media file having a broadcast duration less than 30 minutes would receive a greater time score, as compared to media content having broadcast duration greater than the median ride duration. In alternative examples, the minimum remaining travel duration across multiple riders is used as a threshold as to increase or decrease the time score associated with a particular media content file.

With still further reference to equation (1), an example calculation of score_{rating} is represented by equation (4) below.

$$s c o r {e}_{rating} = \frac{{Σ}_{k = 1}^{n} {R}_{k}}{n} * {e}^{{f}_{k} ( t )} \qquad ( 4 )$$

In equation (4) above, an average rating is compiled by summing a rating value Rₖ for each of n total number of users, then dividing the summed rating by the total number of users n. The average rating score may further be normalized by a time function. That is fₖ(t) may be arranged to always provide a negative value such that e^{f}^{ₖ}^{(t)} is less than one. In this way, score_{rating} may be normalized across a number of different scoring systems, for example as originated from different media players.

Thus according to the examples provided above the overall score function F of equation (1) representing media preferences may be expressed as equation (5) below.

$$F = {w}_{1} * {Σ}_{k = 1}^{n} * \frac{{N}_{k}}{rank} + {w}_{2} * \frac{{Σ}_{1}^{n} trip left time \text{/} n}{song period} + {w}_{3} * \frac{{Σ}_{1}^{n} rate of the song}{n} * {e}^{f ( t )} \qquad ( 5 )$$

According to further examples, an initial media file to be broadcast upon user's entry into the vicinity of the infotainment system may be further influenced by a desired to a achieve a positive perceived first impression. For example, the first song at the time of entry of a user may be purposely selected from the favorites of that particular user. In another example, only media content have a preference score greater than a predetermined first impression threshold for a particular user is selected for broadcast for the first arrival media for that user. Selection of the first song upon entry may generally be selected to provide a positive first impression of the entering user.

According to further examples, users can connect and interact with the infotainment system during broadcast of a playlist using an app provided at each user device. Users can view the active media file queues on the playlist, and exchange chat messages with other riders concerning played or queued media files. Users may also interact with the infotainment system itself to influence the media file playlist. For instance, users can manually influence the queue by requesting real-time to add an upcoming song to the playlist, or to remove an upcoming song from the playlist. Users may request to adjust volume level. The control algorithm of the infotainment system may arbitrate between various requests across different users to generate a composite public playlist by scoring the candidate media files as describe above or using other ranking methods.

The infotainment system may be further programmed to adjust the upcoming the media content playlist as well as adjust a volume level based on additional rules-based strategies. For example, if a majority of users submit similar requests, then the infotainment system recognize preference trends and adjust preference scoring such that the playlist is adjusted to reflect the changes in collective user preferences.

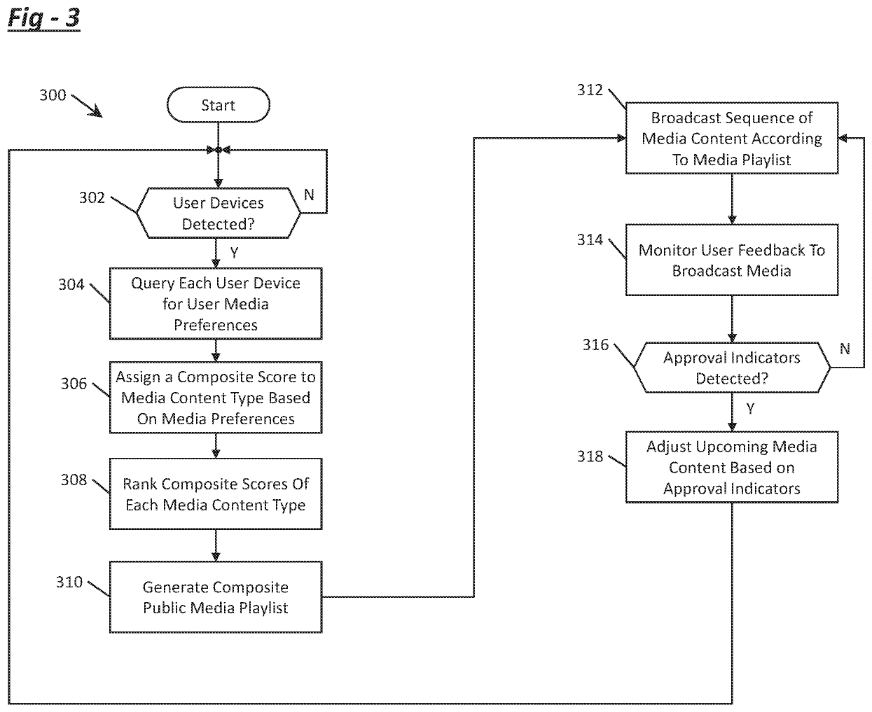

Referring to FIG. 3, a method of managing media content is depicted by flowchart 300. At step 302 the method includes determining whether any user devices are detected within a vicinity of a host infotainment system. As discussed above this may also include determining when devices will be in the vicinity during a known upcoming time period. For example, a scheduled passenger reservation on a vehicle shuttle having an infotainment system according to the present disclosure may indicate an upcoming presence of a user device in the vicinity of the infotainment system.

If at step 302 one or more user devices is detected, the method includes querying at step 304 each detected user device for a user media preference. The infotainment system may query for a variety of data that indicate a user's media content preferences. The data may comprise various categories including, but not limited to, user demographic data, user media consumption pattern data, and environmental factor data. Each broad category may further include specific data types from various sources as discussed herein.

At step 306 the method includes assigning a composite score to one or more media types based on a plurality of media preference factors received from the user devices. As discussed above, the composite score may be based on arbitrating different preference factors received from each of a plurality of user devices. This may include for example weighting various categories and deriving the composite score in order to rank media content types to determine the best overall suitability for all of the detected users.

At step 308 the method includes ranking a composite score associated with each of a plurality of media content types. Once a sequence is established based on the acceptability of various users as indicated by media preferences, the method includes generating at step 310 a media content playlist based on the ranked composite scores.

At step 312 the method includes broadcasting a sequence of media content according to the media file playlist. As discussed above, the media content may be from any of a number of media sources including remote sources such as streaming services of other download sources. Alternatively, the method may include obtaining media content from the user devices directly for broadcast to all of the users in the vicinity of the infotainment system.

At step 314 the method includes monitoring user feedback to broadcast media. The monitoring may include monitoring at least some combination of textual user feedback, audible user feedback, and visual user feedback. The method includes analyzing the feedback data for user approval indicators that show approval or disapproval of broadcast media content. If at step 316 no approval indicators are detected within the user feedback, the method includes continuing to broadcast media content according to the media playlist.

If at step 316 approval indicators are detected from any of the user feedback sources, the method includes using the approval indicators to adjust at step 318 the upcoming media content in the media playlist based on the approval indicators. In some examples, the adjustment is mad by revising the composite score of certain media content based on user feedback pertaining to similar content. More specifically, an artist's scores for all of their songs may be negatively impacted by negative user feedback to a particular broadcast song by the same artist. Generally, the method may include making assumptions about acceptability of upcoming media content based on real-time user feedback to broadcast media content. In other examples, the user feedback may be to the media playlist directly in the way of additions to or subtractions from the upcoming media playlist. A user request to modify the sequence of media content of the playlist may be considered direct approval indicator such that the method similarly adjusts the content based on the feedback.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An infotainment system comprising:
a transceiver to receive media content from a plurality of sources and communicate with a plurality of user devices;
a broadcast device configured to broadcast media content; and
a controller programmed to
query the user devices for at least one media preference factor, and
generate a composite public playlist based on an arbitration between different media preference factors received from the user devices.

2. The infotainment system of claim 1 wherein the at least one media preference factor includes at least one of a user demographic, a user media consumption pattern, and an environmental factor.

3. The infotainment system of claim 2 wherein the environmental factor includes at least one of: a traffic condition, a time of day, a geographic location, a user route destination, a weather condition, and a user route duration.

4. The infotainment system of claim 3 wherein the controller is further programmed to selecting an upcoming media file as next in the composite public playlist such that the upcoming media file has a play duration less than a detected user route duration.

5. The infotainment system of claim 1 wherein the plurality of user devices includes at least one of present passenger user devices and upcoming passenger user devices.

6. The infotainment system of claim 1 wherein the arbitration between the at least one media preference factor includes assigning a user preference score to a media type associated with one of the plurality user devices and generating a composite score for the media type based on different user preference scores from different ones of the plurality of user devices.

7. The infotainment system of claim 6 wherein the controller is further programmed to monitor messages transmitted between the plurality of user devices, and in response to approval indicators within the messages corresponding to a first media type, adjust the composite score generated for the first media type.

8. The infotainment system of claim 6 wherein the controller is further programmed to monitor a user response to a media type including at least one of an audible response and a visual response, and in response to approval indicators within the user response corresponding to a first media type, adjust the composite score generated for the first media type.

9. A method of managing media content comprising:
querying a user media preference from each of a plurality of user devices;
assigning a composite score to a media type based on a plurality of media preference factors;
generating a media content playlist based on ranking a composite score associated with each of a plurality of media content types; and
broadcasting a sequence of media content according to the media file playlist.

10. The method of claim 9 wherein the plurality of media preference factors includes at least one of a user demographic, a user media consumption pattern, and an environmental factor.

11. The method of claim 10 wherein the environmental factor includes at least one of: a traffic condition, a time of day, a geographic location, a user route destination, a weather condition, and a user route duration.

12. The method of claim 9 further comprising monitoring a user response to a media type including at least one of an audible response and a visual response, and in response to approval indicators within the user response, modifying the media content playlist.

13. The method of claim 9 further comprising monitoring messages transmitted between the plurality of user devices, and in response to approval indicators within the messages, modifying the media content playlist.

14. The method of claim 9 further comprising increasing the composite score associated with media content having a play duration less than an overlapping passenger ride duration.

15. A vehicle comprising:
an infotainment system programmed to communicate with a plurality of user devices, receive media content from a plurality of sources, and broadcast the media content to users in a vicinity; and
a controller programmed to
query the plurality of user devices for user media preferences,
generate a ranking of candidate media content types based on the user media preferences,
generate a public media playlist for broadcast to the users in the vicinity based on the ranking, and
cause the infotainment system to receive media content according to the media playlist.

16. The vehicle of claim 15 wherein the user media preferences include at least one of a user demographic, a user media consumption pattern, and an environmental factor.

17. The vehicle of claim 16 wherein the environmental factor includes at least one of: a traffic condition, a time of day, a geographic location, a user route destination, a weather condition, and a user route duration.

18. The vehicle of claim 15 wherein the plurality of user devices includes at least one of present passenger user devices and upcoming passenger user devices.

19. The vehicle of claim 15 wherein the controller is further programmed to monitor messages transmitted between the plurality of user devices, and in response to approval indicators within the messages adjust the ranking of candidate media files.

20. The vehicle of claim 15 wherein the controller is further programmed to monitor a user response to a media type, the user response including at least one of an audible response and a visual response, and in response to detecting an approval indicator within the user response, adjust the ranking of candidate media files.
